(19) United States
(12) Patent Application Publication
(10) Pub. No.: US 2017/0349167 A1
(43) Pub. Date: Dec. 7, 2017

(54) REAL-TIME DRIVER-CONTROLLED DYNAMIC VEHICLE BALANCE CONTROL SYSTEM

(71) Applicant: GM Global Technology Operations LLC, Detroit, MI (US)

(72) Inventors: Jason D. Fahland, Fenton, MI (US); Joshua R. Auden, Brighton, MI (US); Christopher J. Barber, West Bloomfield, MI (US)

(21) Appl. No.: 15/175,350

(22) Filed: Jun. 7, 2016

(51) Int. Cl. B60W 30/045; B60W 10/12; B60W 30/18; B60W 10/22; B60W 10/30

(52) U.S. Cl. CPC B60W 30/045; B60W 10/22; B60W 10/30; B60W 30/18145; B60W 10/12; B60W 2710/12; B60W 2540/18; B60W 2720/14; B60W 2720/16; B60W 2720/26; B60W 2720/406; B60W 2550/402

(57) ABSTRACT

An automotive vehicle includes a steering system and a steering wheel configured to control the steering system. The vehicle additionally includes a dynamic vehicle balance control system configured to modify a yaw rate of the vehicle during a drive cycle to modify understeer behavior. The vehicle also includes a sensor configured to detect an operator force applied to the steering wheel. The vehicle further includes a controller. The controller is configured to, in response to a detected operator force applied to the steering wheel, command the dynamic vehicle balance control system to modify the yaw rate of the vehicle.

### TECHNICAL FIELD

The present disclosure relates to automotive vehicles, and more particularly to automotive vehicle having at least one active system for affecting vehicle understeer.

### INTRODUCTION

In an automotive vehicle, understeer and oversteer refer to differences between a yaw rate commanded at the steering wheel and an actual yaw rate of the vehicle. Understeer refers to the phenomenon when the actual yaw rate of the vehicle is less than that commanded at the steering wheel, while oversteer refers to the phenomenon when the actual yaw rate of the vehicle is greater than that commanded at the steering wheel. Various vehicle systems, including suspension and vehicle aerodynamic surfaces, may contribute to understeer or oversteer.

### SUMMARY

An automotive vehicle according to the present disclosure includes a steering system and a steering wheel configured to control the steering system. The vehicle additionally includes a dynamic vehicle balance control system configured to modify a yaw rate of the vehicle during a drive cycle to modify understeer behavior. The vehicle also includes a sensor configured to detect an operator force applied to the steering wheel. The vehicle further includes a controller. The controller is configured to, in response to a detected operator force applied to the steering wheel, command the dynamic vehicle balance control system to modify the yaw rate of the vehicle.

According to various embodiments, the sensor includes a pressure transducer arranged to detect an operator translational force applied to the steering wheel or a pressure transducer arranged to detect an operator pivot moment applied to the steering wheel.

According to an exemplary embodiment, the steering wheel is configured to move a calibrated distance in response to an operator force applied to the steering wheel.

According to an exemplary embodiment, the dynamic vehicle balance control system includes an active aerodynamic control member having a first position and a second position. In such an embodiment, commanding the dynamic vehicle balance control system to modify the yaw rate of the vehicle includes commanding the aerodynamic control member to move from the first position to the second position to adjust a pitch moment of the vehicle.

According to another exemplary embodiment, the dynamic vehicle balance control system includes an electronic limited slip differential. In such an embodiment, commanding the dynamic vehicle balance control system to modify the yaw rate of the vehicle includes commanding the electronic limited slip differential to unevenly distribute torque to vehicle wheels.

According to yet another exemplary embodiment, the dynamic vehicle balance control system includes a first dynamic vehicle balance control subsystem and a second dynamic vehicle balance control subsystem. In such an embodiment, the controller is configured to, in response to the detected operator force applied to the steering wheel and vehicle speed being below a threshold, command the first dynamic vehicle balance control subsystem to modify the yaw rate of the vehicle. The controller is further configured to, in response to the detected operator force applied to the steering wheel and vehicle speed not being below the threshold, command the second dynamic vehicle balance control subsystem to modify the yaw rate of the vehicle.

A method of controlling an automotive vehicle according to the present disclosure includes providing an automotive vehicle with at least one dynamic vehicle balance control system. The method additionally includes controlling the balance control system according to a default schedule during a drive cycle. The method further includes, in response to an operator input, controlling the dynamic vehicle balance control system to modify a vehicle yaw rate to increase or decrease an understeer resulting from the default schedule.

According to an exemplary embodiment, the dynamic vehicle balance control system includes an active aero system. In such an embodiment, controlling the dynamic vehicle balance control system to modify a vehicle yaw rate includes controlling an aerodynamic member of the active aero system.

According to another exemplary embodiment, the dynamic vehicle balance control system includes an electronic limited slip differential. In such an embodiment, controlling the dynamic vehicle balance control system to modify a vehicle yaw rate includes controlling a clutch pressure of the electronic limited slip differential.

According to various additional embodiments, the dynamic vehicle balance control system includes an active drivetrain device, an active suspension device, an active torque vectoring device, am active rear steering device, an active toe control device, an active camber control device, or an active aero device.

According to various exemplary embodiments, the operator input includes an operator translational force applied to a vehicle steering wheel or an operator pivoting moment applied to a vehicle steering wheel.

According to a further embodiment, the method additionally includes storing the operator input and a location at which the operator input was received in non-transient data memory storage. In response to the vehicle being at the location at which the operator was received during a subsequent trip, the dynamic vehicle balance control system is controlled to modify the vehicle yaw rate in the absence of operator input.

A system for controlling an automotive vehicle according to the present disclosure includes a dynamic vehicle balance control system having a default control schedule. The system additionally includes at least one sensor configured to detect a first operator input requesting an increase in understeer and to detect a second operator input requesting a decrease in understeer. The system further includes a controller. The controller is configured to, in response to the first operator input, control the dynamic vehicle balance control system to increase understeer relative to the default control schedule. The controller is also configured to, in response to the second operator input, control the dynamic vehicle balance control system to decrease understeer relative to the default control schedule.

According to an exemplary embodiment, the system additionally includes a steering wheel. In such an embodiment, the sensor may include a pressure transducer arranged to detect a translational force applied to the steering wheel and/or a pressure sensor arranged to detect a pivoting moment applied to the steering wheel.

According to another exemplary embodiment, the dynamic vehicle balance control system includes an active aerodynamic control member having a first position and a second position. In such an embodiment, controlling the dynamic vehicle balance control system to increase understeer relative to the default control schedule includes controlling the aerodynamic control member to move from the first position to the second position to adjust a pitch moment of the vehicle.

According to an additional exemplary embodiment, the dynamic vehicle balance control system includes an electronic limited slip differential. In such an embodiment, controlling the dynamic vehicle balance control system to increase understeer relative to the default control schedule includes controlling the electronic limited slip differential decrease a pressure of the clutch.

According to various additional embodiments, the dynamic vehicle balance control system includes an active drivetrain device, an active suspension device, an active torque vectoring device, am active rear steering device, an active toe control device, an active camber control device, or an active aero device.

Embodiments according to the present disclosure provide a number of advantages. For example, systems and methods according to the present disclosure enable an operator of an automotive vehicle to modify vehicle handling characteristics, e.g. adjusting an amount of understeer, in real-time. Moreover, an operator may do so using an easily understood and operated input device, e.g. incorporated into the steering wheel.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is an isometric view of a vehicle according to the present disclosure;

FIG. 2 is a schematic representation of a vehicle according to the present disclosure;

FIG. 3 illustrates a first embodiment of an operator-controlled dynamic vehicle balance control interface according to the present disclosure;

FIG. 4 illustrates a second embodiment of an operator-controlled dynamic vehicle balance control interface according to the present disclosure; and

FIG. 5 is a flowchart representation of a method of controlling a vehicle according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

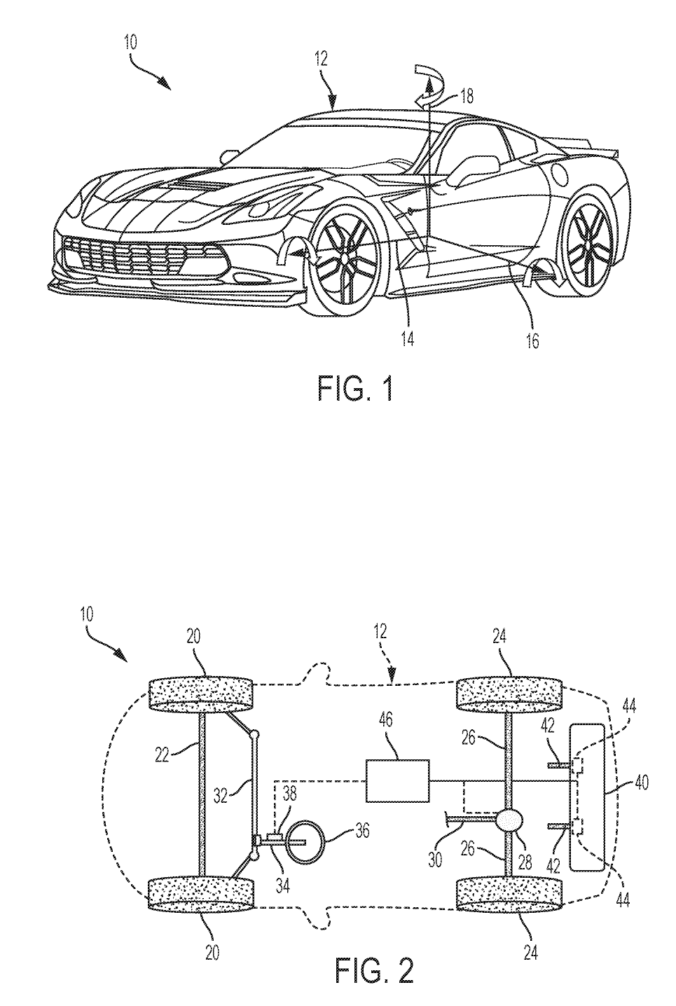

Referring now to FIGS. 1 and 2, an automotive vehicle 10 according to the present disclosure is illustrated. The vehicle 10 includes a body 12 with a longitudinal axis 14 extending from a front portion to a rear portion, a lateral axis 16 extending from a passenger side to a driver side, and a vertical axis 18 extending orthogonal to the longitudinal axis 14 and lateral axis 16. Rotation of the body 12 about the longitudinal axis 14 is referred to as roll, rotation of the body 12 about the lateral axis 16 is referred to as pitch, and rotation of the body 12 about the vertical axis 18 is referred to as yaw.

In this embodiment, the vehicle 10 is arranged as a rear-wheel-drive vehicle. It should be noted that other considered embodiments may be configured otherwise, such as front-wheel-drive or all-wheel-drive.

The vehicle 10 includes two front traction wheels 20 coupled to a front axle 22. In addition, the vehicle 10 includes two rear traction wheels 24 coupled to rear half shafts 26. An electronic limited-slip differential (eLSD) 28 is configured to distribute torque from a drive shaft 30 to the rear half shafts 26. The eLSD 28 is configured to selectively permit a speed differential between the respective rear half shafts 26.

A steering system 32 is configured to pivot the front wheels 20 to steer the vehicle. The steering system 32 is configured to pivot the front wheels 20 in response to a steering force from a steering column 34 based on an operator input to a steering wheel 36. A pressure transducer 38 is coupled to the steering column 34, as will be discussed in further detail below.

A rear wing 40 is provided at a rear portion of the body 12. The rear wing 40 acts as an aerodynamic control member configured to generate a downforce at the rear portion of the body 12. The rear wing 40 is carried by at least one stanchion 42. At least one actuator 44 is provided to pivot the rear wing 40 relative to the stanchion 42 and adjust the angle of attack of the rear wing 40. The actuator 44 is configured to pivot the rear wing 40 between at least a first position and a second position, distinct from the first position. The actuator 44 may thus adjust the downforce generated by the rear wing 40. Because the actuator 44 may modify aerodynamic characteristics of the rear wing 40 during a drive cycle, the rear wing 40 may be referred to as an “active” aerodynamic control member.

The eLSD 28, pressure transducer 38, and actuator 44 are all in communication with or under the control of a controller 46. The controller 46 is configured to control the eLSD 28, actuator 44, and optionally one or more additional systems, as will be discussed in further detail below. While depicted as a single controller in FIG. 2, the controller 46 may include one or more other controllers, collectively referred to as a “controller.” The controller 46 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

Under certain conditions, during high speed turns the vehicle 10 may experience understeer or oversteer. Understeer refers to situations when the vehicle travels straighter than the trajectory commanded by the operator, e.g. the actual yaw rate of the vehicle is less than desired. This may occur, for example, when the front tires reach their limit of adhesion during a turn while the rear tires still maintain traction. Oversteer refers to situations when the vehicle turns more sharply than the trajectory commanded by the operator, e.g. the actual yaw rate of the vehicle is greater than desired. This may occur, for example, when the rear tires reach their limit of adhesion during a turn while the front tires still maintain traction. While oversteer is generally viewed as less advantageous, the vehicle 10 may be configured to provide a quantity of understeer.

Various vehicle systems may be controlled to affect understeer behavior of the vehicle 10. As an example, the rear wing 40 generates a downforce at the rear portion of the body 12. The downforce creates a pitch moment about the center of gravity of the body 12. By controlling the actuator 44 to adjust the angle of attack of the rear wing 40, the magnitude of the downforce and, in turn, the magnitude of the pitch moment may be adjusted. By adjusting the pitch moment, the relative loading of the front tires 20 and rear tires 24, and likewise the relative lateral force of the front tires 20 and rear tires 24 during a turn, may be modified. By adjusting the relative lateral force of the front tires 20 and rear tires 24, the controller 46 may affect whether and when the front tires 20 and rear tires 24 reach their limit of adhesion during a turn and, in turn, affect the understeer behavior of the vehicle 10.

In other considered embodiments, the rear wing 40 may be part of an active aerodynamic control system, or “active aero” system. In such embodiments, the active aero system may include one or more additional active aerodynamic control members provided at other portions of the vehicle. Any additional active aerodynamic control members may likewise be controlled to adjust vehicle pitch moment or otherwise influence understeer behavior of the vehicle 10.

As another example, the eLSD 28 may be controlled to increase or decrease slippage, e.g. to adjust the allowable speed differential between the respective rear half shafts 26. Generally, a reduction in slippage corresponds to an increase in understeer. Thus, the controller 46 may control the eLSD 28 to affect the understeer behavior of the vehicle 10.

In other considered embodiments, other systems may also be controlled to affect understeer behavior of the vehicle 10 in real-time, e.g. during a drive cycle in response to a command from a controller. Such systems may include other active drivetrain devices, active suspension devices such as active springs or active MR dampers, active torque vectoring, active rear steering, active toe control, active camber control, active aero devices, and/or other active pitch control or roll control devices capable of modifying vehicle yaw rate during a drive cycle.

Collectively, the actuator 44, eLSD 28, and other systems for affecting the understeer behavior of the vehicle 10 in real-time may be referred to as dynamic vehicle balance control systems.

Such systems, including the actuator 44, eLSD 28, and other devices, are generally controlled according to one or more schedules, e.g. as a function of vehicle speed, acceleration, traction, and/or other parameters. The schedules are configured to provide consistent behavior for a given set of operating parameters. In an exemplary embodiment, the schedules are provided in non-transient data memory accessible by the controller 46.

However, different operators have different expectations and/or preferences regarding vehicle dynamic response during high-speed turns. Some operators may prefer a relatively high amount of understeer on corner entry, while other operators may prefer a relatively low amount of understeer. The schedule is generally tuned toward an average driver preference, which may result in decreased satisfaction for drivers who prefer a greater or lesser amount of understeer on corner entry.

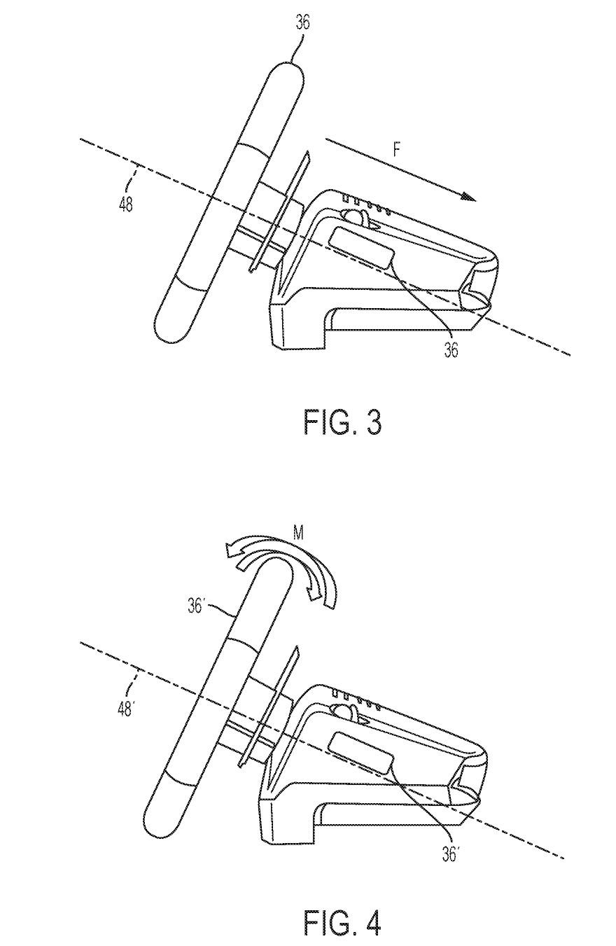

Referring now to FIG. 3, a first embodiment of an operator-controlled dynamic vehicle balance control interface according to the present disclosure is illustrated. The steering wheel 36 is configured to turn about a central axis 48 in response to an operator input, similar to known steering wheels. In addition, the steering wheel 36 is provided with the pressure transducer 38 coupled to the steering column 34. The pressure transducer 38 is configured to detect a force F applied to the steering wheel 36 in a direction generally parallel the central axis 48 and provide a signal corresponding to a magnitude of the force F.

In an exemplary embodiment, the steering wheel 36 is configured to translate parallel to the central axis 48 under the force F. In an exemplary embodiment, the allowable distance of translation and resistance to translation are calibrated to provide a desired force feedback to an operator. In addition, a so-called “dead zone” may be provided, such that small applications of force to the steering wheel 36 do not result in a modification to understeer behavior. Understeer behavior is only modified in response to a force application exceeding a threshold force.

In response to the signal from the pressure transducer 38 corresponding to the magnitude of the force F, the controller 46 is configured to control at least one dynamic vehicle balance control system to modify understeer behavior of the vehicle.

In an exemplary embodiment, in response to a force F corresponding to an operator pushing on the steering wheel 36, the controller 46 controls at least one dynamic vehicle balance control system to decrease understeer, while in response to a force F corresponding to an operator pulling on the steering wheel 36, the controller 46 controls at least one dynamic vehicle balance control system to increase understeer. Of course, other configurations may be provided.

In an exemplary embodiment, controlling a dynamic vehicle balance control system to increase or decrease understeer includes controlling the dynamic vehicle balance control system to deviate from the base schedule. The deviation may be a scalar value corresponding to the magnitude of the force F. Thus, a higher magnitude force F will result in a larger change in understeer behavior.

In various embodiments, a single dynamic vehicle balance control system may be controlled, or multiple dynamic vehicle balance control systems or subsystems may be coordinated together to affect understeer. In an exemplary embodiment, a first dynamic vehicle balance control system may be controlled to affect understeer in response to vehicle speed being below a first threshold, and a second dynamic vehicle balance control system may be controlled to affect understeer in response to vehicle speed being above a first threshold.

In addition to providing real-time understeer control, operator inputs received by the pressure transducer 38 may be recorded in non-transient data storage and processed for subsequent use.

As an example, the controller 46 may be configured to activate a track learning mode in response to an operator input. With the track learning mode active, an operator may drive the vehicle 10 around a track while providing inputs to the steering wheel 36 indicating desired understeer behavior. The inputs are stored, along with a location at which the input was received, to “learn” the operator's preferences for the track. During subsequent laps around the same track after the operator's preferences are learned, the controller 46 may automatically control the at least one dynamic vehicle balance control system to provide the desired understeer behavior, without requiring the operator to provide inputs to the steering wheel 36.

As another example, operator inputs to the steering wheel 36 indicating desired understeer behavior may be communicated to a remote processing location, e.g. via cellular data transmission, enabling subsequent analysis to aid a manufacturer in chassis tuning. In such embodiments, operator opt-in may be required before communicating the operator inputs to the remote processing location.

Variations on the above system are considered within the scope of the present disclosure. Referring now to FIG. 4, an alternative embodiment of an operator-controlled dynamic vehicle balance control interface according to the present disclosure is illustrated. A steering wheel 36′ is configured to turn about a central axis 48′ in response to an operator input. In addition, the steering wheel 36′ is provided with a pressure transducer 38′ coupled to a steering column 34′. The pressure transducer 38′ is configured to detect a pivoting moment M applied to the steering wheel 36′ in a direction generally perpendicular the central axis 48′ and provide a signal corresponding to a magnitude of the pivoting moment M. Understeer behavior may be adjusted based on the signal in a generally similar manner as discussed above with respect to FIG. 3.

Other considered embodiments include, but are not limited to, providing a throttle grip or actuatable paddles on a vehicle steering wheel. These or other similar operator interfaces may be used to signal, in real-time, an operator's desire for increased or decreased understeer.

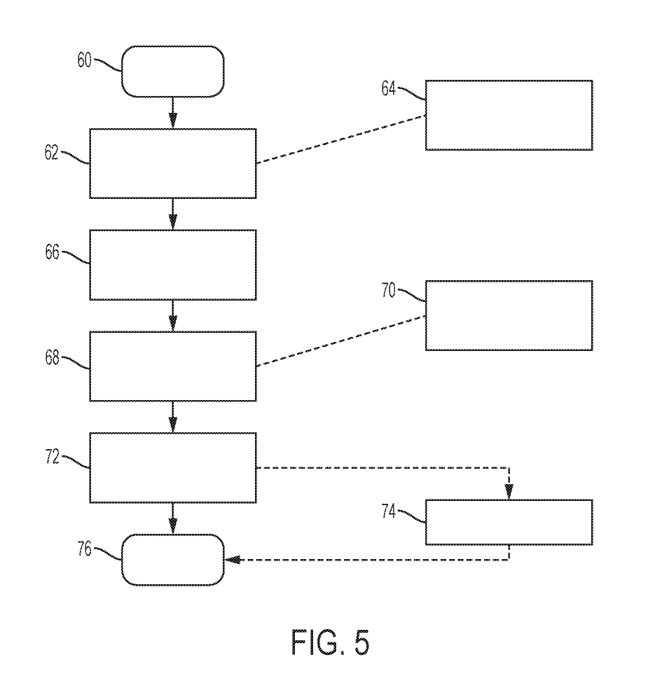

Referring now to FIG. 5, a method of controlling a vehicle according to the present disclosure is illustrated in flowchart form. The method begins at block 60. A vehicle is provided with at least one dynamic vehicle balance control system, as illustrated at block 62. The dynamic vehicle balance control system may include an active aero system and/or an eLSD, as illustrated at block 64. The dynamic vehicle balance control system is operated according to a default schedule during a drive cycle, as illustrated at block 66. An operator input is received, as illustrated at block 68. The operator input may include a translational force or pivoting moment applied to a steering wheel, as illustrated at block 70. In response to the operator input, the dynamic vehicle balance control system is controlled to modify a vehicle yaw rate, e.g. to increase or decrease an understeer resulting from the default schedule, as illustrated at block 72. The operator input may be stored for subsequent processing, as illustrated at block 74. The method ends at block 76.

As may be seen, systems and methods according to the present disclosure enable an operator of an automotive vehicle to modify vehicle handling characteristics, e.g. adjusting an amount of understeer, in real-time. Moreover, an operator my do so using an easily understood and operated input device, e.g. incorporated into the steering wheel.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
a steering system;
a steering wheel configured to control the steering system;
a dynamic vehicle balance control system configured to modify a yaw rate of the vehicle during a drive cycle to control understeer behavior;
a sensor configured to detect an operator force applied to the steering wheel; and
a controller configured to, in response to a detected operator force applied to the steering wheel, command the dynamic vehicle balance control system to modify the yaw rate of the vehicle.

2. The automotive vehicle of claim 1, wherein the sensor comprises a pressure transducer arranged to detect a translational force applied to the steering wheel.

3. The automotive vehicle of claim 1, wherein the sensor comprises a pressure transducer arranged to detect a pivoting moment applied to the steering wheel.

4. The automotive vehicle of claim 1, wherein the steering wheel is configured to move a calibrated distance in response to an operator force applied to the steering wheel.

5. The automotive vehicle of claim 1, wherein the dynamic vehicle balance control system includes an active aerodynamic control member having a first position and a second position, and wherein commanding the dynamic vehicle balance control system to modify the yaw rate of the vehicle includes commanding the aerodynamic control member to move from the first position to the second position to adjust a pitch moment of the vehicle.

6. The automotive vehicle of claim 1, wherein the dynamic vehicle balance control system includes an electronic limited slip differential having a clutch, and wherein commanding the dynamic vehicle balance control system to modify the yaw rate of the vehicle includes commanding the electronic limited slip differential to modify a pressure of the clutch.

7. The automotive vehicle of claim 1, wherein the dynamic vehicle balance control system includes a first vehicle balance control subsystem and a second vehicle balance control subsystem, and wherein the controller is configured to, in response to the detected operator force applied to the steering wheel and vehicle speed being below a threshold, command the first vehicle balance control subsystem to modify the yaw rate of the vehicle and, in response to the detected operator force applied to the steering wheel and vehicle speed being equal to or above the threshold, command the second vehicle balance control subsystem to modify the yaw rate of the vehicle.

8. A method of controlling an automotive vehicle comprising:
providing an automotive vehicle with at least one dynamic vehicle balance control system;
controlling the dynamic vehicle balance control system according to a default schedule during a drive cycle; and
in response to an operator input, controlling the dynamic vehicle balance control system to modify a vehicle yaw rate to increase or decrease an understeer relative to the default schedule.

9. The method of claim 8, wherein the dynamic vehicle balance control system includes an active aero system, and wherein controlling the dynamic vehicle balance control system to modify a vehicle yaw rate comprises controlling an aerodynamic member of the active aero system.

10. The method of claim 8, wherein the dynamic vehicle balance control system includes an electronic limited slip differential, and wherein controlling the dynamic vehicle balance control system to modify a vehicle yaw rate comprises controlling a clutch pressure of the electronic limited slip differential.

11. The method of claim 8, wherein the dynamic vehicle balance control system includes an active drivetrain device, an active suspension device, an active torque vectoring device, am active rear steering device, an active toe control device, an active camber control device, or an active aero device.

12. The method of claim 8, wherein the operator input includes an operator translational force applied to a vehicle steering wheel.

13. The method of claim 8, wherein the operator input includes an operator pivoting moment applied to a vehicle steering wheel.

14. The method of claim 8, further comprising:
storing the operator input and a geographic location at which the operator input was received in non-transient data memory storage; and
in response to the vehicle being at a corresponding geographic location during a subsequent drive cycle, controlling the dynamic vehicle balance control system to modify the vehicle yaw rate in an absence of operator input.

15. A system for controlling a vehicle, comprising:
a dynamic vehicle balance control system having a default control schedule;
at least one sensor configured to detect a first operator input requesting an increase in understeer and to detect a second operator input requesting a decrease in understeer; and
a controller configured to, in response to the first operator input, control the dynamic vehicle balance control system to increase understeer relative to the default control schedule and to, in response to the second operator input, control the dynamic vehicle balance control system to decrease understeer relative to the default control schedule.

16. The system of claim 15, further comprising a steering wheel, wherein the at least one sensor includes a pressure transducer arranged to detect a translational force applied to the steering wheel.

17. The system of claim 15, further comprising a steering wheel, wherein the at least one sensor includes a pressure transducer arranged to detect a pivoting moment applied to the steering wheel.

18. The system of claim 15, wherein the dynamic vehicle balance control system includes an active aerodynamic control member having a first position and a second position, and wherein controlling the dynamic vehicle balance control system to increase understeer relative to the default control schedule includes controlling the aerodynamic control member to move from the first position to the second position to adjust a pitch moment of the vehicle.

19. The system of claim 15, wherein the dynamic vehicle balance control system includes an electronic limited slip differential, and wherein controlling the dynamic vehicle balance control system to increase understeer relative to the default control schedule includes controlling the electronic limited slip differential decrease a pressure of the clutch.

20. The system of claim 15, wherein the dynamic vehicle balance control system includes an active drivetrain device, an active suspension device, an active torque vectoring device, am active rear steering device, an active toe control device, an active camber control device, or an active aero device.
